(19) United States
(12) Patent Application Publication
(10) Pub. No.: US 2024/0323743 A1
(43) Pub. Date: Sep. 26, 2024

(54) TERMINAL DEVICE, NETWORK DEVICE, AND METHOD FOR INFORMATION PROCESSING

(71) Applicant: GUANGDONG OPPO MOBILE TELECOMMUNICATIONS CORP., LTD., Dongguan (CN)

(72) Inventor: Wenqiang TIAN, Dongguan, (CN)

(21) Appl. No.: 18/734,864

(22) Filed: Jun. 5, 2024

Related U.S. Application Data
(63) Continuation of application No. PCT/CN2021/135940, filed on Dec. 7, 2021.

(51) Int. Cl. H04W 24/10

(52) U.S. Cl. CPC H04W 24/10

(57) ABSTRACT

Embodiments of the disclosure relate to a terminal device, a network device, and a method for information processing. The terminal device includes a processor, a memory, and a transceiver. The memory is configured to store computer programs. The processor is configured to invoke and execute the computer programs stored in the memory, to input first information into a channel state discriminative model, to obtain corresponding channel state discriminative information. The transceiver is configured to send the channel state discriminative information.

### CROSS-REFERENCE TO RELATED APPLICATION(S)

This application is a continuation of International Application No. PCT/CN2021/135940, filed Dec. 7, 2021, the entire disclosure of which is incorporated herein by reference.

### TECHNICAL FIELD

Embodiments of the disclosure relate to the field of communication, and more particularly, to a terminal device, a network device, and a method for information processing.

### BACKGROUND

In a wireless communication system, there are uplink and downlink reference signals, and these reference signals are used to achieve various objectives such as channel estimation. A terminal device determines current channel state information (CSI) by measuring these reference signals, and reports the current CSI to a network device, so that the network device configures, according to the current channel condition, a data transmission mode that is proper and efficient. The terminal device encodes original channel information that is to be reported, and then sends the channel information after encoding. The network device recovers the received information to obtain the recovered channel information. How to improve accuracy of channel information recovery is a problem to be solved.

### SUMMARY

Embodiments of the disclosure provide a terminal device. The terminal device includes a processor, a memory, and a transceiver. The memory is configured to store computer programs. The processor is configured to invoke and execute the computer programs stored in the memory, to input first information into a channel state discriminative model, to obtain corresponding channel state discriminative information. The transceiver is configured to send the channel state discriminative information.

Embodiments of the disclosure further provide a network device. The network device includes a processor, a memory, and a transceiver. The memory is configured to store computer programs. The processor is configured to invoke and execute the computer programs stored in the memory, to decode channel state indication information by using a decoding unit corresponding to the channel state indication information.

Embodiments of the disclosure provide a method for information processing. The method includes the following. A network device decodes channel state indication information by using a decoding unit corresponding to the channel state indication information.

### BRIEF DESCRIPTION OF THE DRAWINGS

FIG. 1 is a schematic diagram illustrating an application scenario according to embodiments of the disclosure.

FIG. 2 is a schematic diagram illustrating a manner for obtaining and indicating channel state information (CSI) in a wireless communication system.

FIG. 3 is a schematic diagram illustrating a basic structure of a neural network.

FIG. 4 is a schematic flowchart of a method 400 for information indication according to embodiments of the disclosure.

FIG. 5 is a schematic diagram illustrating an implementation of CSI recovery according to embodiments of the disclosure.

FIG. 6 is a schematic structural diagram illustrating a channel state discriminative model according to embodiments of the disclosure.

FIG. 7A is a schematic diagram illustrating a manner for indicating type information according to embodiments of the disclosure.

FIG. 7B is a schematic diagram illustrating another manner for indicating type information according to embodiments of the disclosure.

FIG. 7C is a schematic diagram illustrating another manner for indicating type information according to embodiments of the disclosure.

FIG. 8A is a schematic diagram illustrating an implementation of sending a channel state discriminative model.

FIG. 8B is a schematic diagram illustrating another implementation of sending a channel state discrimination model.

FIG. 9 is a schematic flowchart of a method 900 for information processing according to embodiments of the disclosure.

FIG. 10 is a schematic structural diagram of a terminal device 1000 according to embodiments of the disclosure.

FIG. 11 is a schematic structural diagram of a network device 1100 according to embodiments of the disclosure.

FIG. 12 is a schematic structural diagram of a communication device 1200 according to embodiments of the disclosure.

FIG. 13 is a schematic structural diagram of a chip 1300 according to embodiments of the disclosure.

### DETAILED DESCRIPTION

The following will describe technical solutions of embodiments of the disclosure with reference to the accompanying drawings in the embodiments of the disclosure.

It should be noted that, terms such as “first” and “second” in the specification of embodiments, claims of the disclosure, and the accompanying drawings are used to distinguish similar objects, and are not necessarily used to describe a particular sequence or order. The objects described by “first” and “second” may be the same or different.

The technical solutions of the embodiments of the disclosure may be applied to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), a 5th-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, etc. Embodiments of the disclosure can also be applied to these communication systems.

Optionally, the communication system in embodiments of the disclosure may be applied to a carrier aggregation (CA) scenario, or may be applied to a dual connectivity (DC) scenario, or may be applied to a standalone (SA) network deployment scenario.

There is no limitation on the spectrum applied in embodiments of the disclosure. For example, embodiments of the disclosure may be applied to a licensed spectrum, or may be applied to an unlicensed spectrum.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc. The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or some of functions of a smart phone, and for example, various types of smart bands and smart jewelries for physical monitoring, of which each is dedicated to application functions of a certain type and required to be used together with other devices such as a smart phone.

The network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, a network device in a future evolved PLMN, etc.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

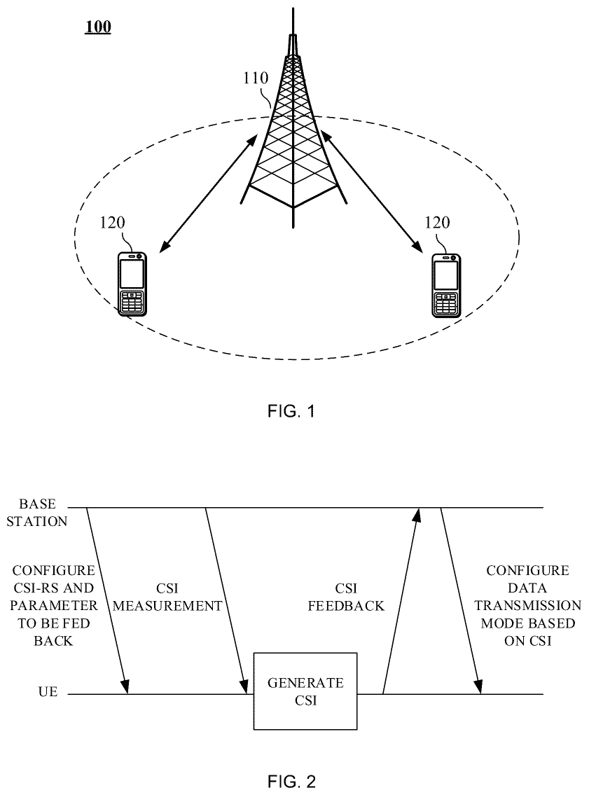

FIG. 1 exemplarily illustrates one network device 110 and two terminal devices 120. Optionally, a wireless communication system 100 may include multiple network devices 110, and there may be other quantities of terminal devices 120 in a coverage area of each of the network devices 110. Embodiments of the disclosure are not limited in this regard. Embodiments of the disclosure may be applied to one terminal device 120 and one network device 110, or may be applied to one terminal device 120 and another terminal device 120.

Optionally, the wireless communication system 100 may further include other network entities, such as a mobility management entity (MME), an access and mobility management function (AMF), and embodiments of the disclosure are not limited in this regard.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that there is an association between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In order to facilitate understanding of the technical solutions of embodiments of the disclosure, the following will describe the related art of embodiments of the disclosure. The following related art as an optional solution may be arbitrarily combined with the technical solutions of embodiments of the disclosure, which shall all belong to the protection scope of embodiments of the disclosure. It should be understood that, the basic procedures and basic concepts introduced below do not constitute limitation on embodiments of the disclosure.

Channel state information (CSI) indication is very important both in an LTE system and in an NR system, and is related to performance of multiple-input multiple-output (MIMO) transmission. Generally, CSI indication in an existing system may include an indication of information such as a channel quality indicator (CQI), a precoding matrix indicator (PMI), and a rank indicator (RI). Regarding the procedure thereof, a base station may firstly configure indication parameter information used for CSI indication, for example, which of the CQI, the PMI, the RI, etc. needs to be indicated by a UE. In addition, the base station may configure some reference signals used for CSI measurement, for example, a synchronization signal block (SSB) or a CSI reference signal (CSI-RS). The UE determines a current CSI condition by measuring the reference signals, and determines the indication parameter information to indicate current CSI to the base station, so that the base station configures, according to the current channel condition, a data transmission mode that is proper and efficient. FIG. 2 is a basic flowchart.

There are various designs regarding the reference signals in a current wireless communication system. For example, a downlink reference signal includes a downlink demodulation reference signal (DMRS), a CSI-RS, a downlink phase tracking reference signal (PT-RS), a positioning reference signal (PRS), etc. An uplink reference signal includes a sounding reference signal (SRS), an uplink DMRS, an uplink PT-RS, etc. The designs of these reference signals are mainly intended for completing different tasks, such as channel estimation, phase tracking, positioning, etc.

In recent years, studies on artificial intelligence (AI), especially on neural networks, have achieved remarkable breakthroughs in many fields, and will also play an important role in people's production and life for a long time in the future.

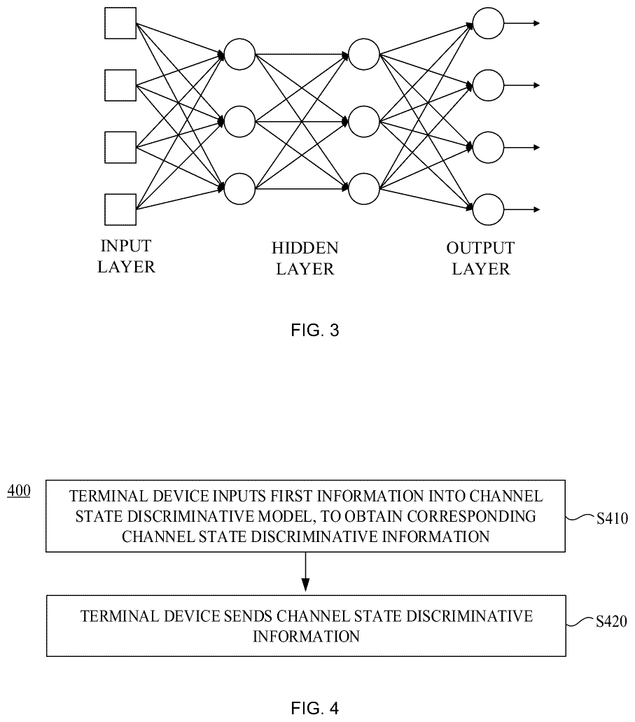

A basic structure of a simple neural network includes an input layer, a hidden layer, and an output layer, as illustrated in FIG. 3. The input layer is responsible for data reception, the hidden layer is responsible for data processing, and a final result is generated at the output layer. In such a structure, each node represents a processing unit and may be considered as simulating a neuron, multiple neurons form a layer of a neural network, and multiple layers of information transfer and processing construct a whole neural network.

With continuous development of studies on neural networks, a neural network deep learning algorithm is also proposed in recent years. More hidden layers are introduced, and feature learning is performed through layer-by-layer training of a neural network with multiple hidden layers, which greatly improves learning and processing capability of a neural network, and is widely applied to aspects such as pattern recognition, signal processing, optimized combination, and abnormality detection.

The basic principle of the current wireless communication system is mostly based on theoretical modeling and parameter selection of an actual communication environment. With higher requirements on flexibility, adaptability, rate, capacity, etc. of a wireless communication system, a gain brought by a working mode of a conventional wireless communication system based on the classic model theory is gradually decreasing. At present, some new studies regarding the above problem have been conducted, and one of these studies relates to obtaining and indicating CSI by means of Al. In such a manner, an encoding end firstly encodes original channel information with aid of an encoding model to generate channel state indication information in order for CSI indication. Then a decoding end decodes the channel state indication information with aid of a decoding model to generate feedback channel information, so as to recover channel quality information. However, if such a manner is adopted, it is hard to meet requirements of an actual channel condition, and performance of CSI recovery at a receiving end is poor.

Embodiments of the disclosure provide a method for information indication. FIG. 4 is a schematic flowchart of a method 400 for information indication according to embodiments of the disclosure. The method may be optionally applied to the system illustrated in FIG. 1, but is not limited thereto. The method includes at least some of the following contents.

S410, a terminal device inputs first information into a channel state discriminative model, to obtain corresponding channel state discriminative information. S420, the terminal device sends the channel state discriminative information.

In some embodiments, the first information includes at least one of: channel information, CSI, or channel state indication information.

The terminal device may send the channel state discriminative information to a network device. The network device determines a decoding unit corresponding to the channel state indication information according to the channel state discriminative information, and decodes the channel state indication information by using the decoding unit determined. The decoding unit corresponding to the channel state indication information may include a decoding unit adapted to decoding the channel state indication information. The decoding unit may be decoder.

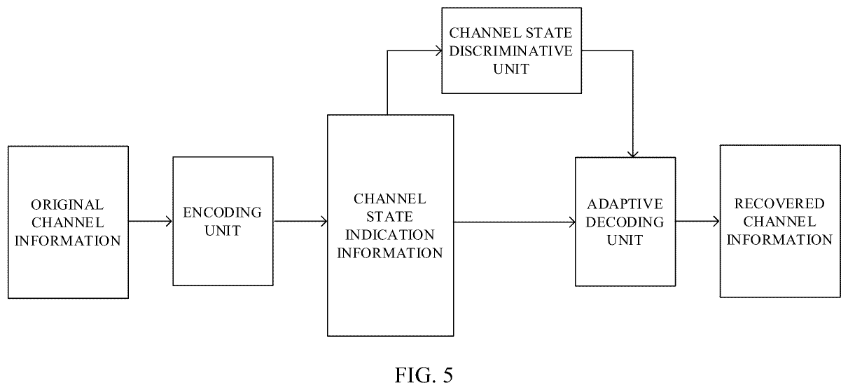

FIG. 5 is a schematic diagram illustrating an implementation of CSI recovery according to embodiments of the disclosure. As illustrated in FIG. 5, original channel information will be input into an encoding unit. An encoding mode used by the encoding unit may be a specific encoding neural network, a specific encoding algorithm, or a specific encoding model. The encoding unit encodes the original channel information, and obtains the channel state indication information after encoding. In some implementations, the channel state indication information after encoding is sent by the terminal device such as a UE, and received by the network device such as a base station. In embodiments of the disclosure, there is no limitation on the manner for forming and obtaining the channel state indication information as well as obtaining the channel state indication information by means of machine learning or non machine learning. The encoding unit may be encoder.

An input (such as the first information) of a channel state discriminative unit (also referred to as the channel state discriminative model) may be the channel information, the CSI, and/or the channel state indication information. An output of the channel state discriminative unit (the channel state discriminative model) may be the channel state discriminative information obtained according to the channel information, the CSI, and/or the channel state indication information. Different channel state discriminative information may correspond to different s, and specifically, each channel state discriminative result corresponds to one decoding unit or multiple channel state discriminative results corresponds to one decoding unit. The channel state discriminative information is output to an adaptive decoding unit, so as to obtain an indication of a channel state type and/or an indication of a decoding unit type. The adaptive decoding unit includes multiple decoding units adapted to different channel states. According to the indication of the channel state type and/or the indication of the decoding unit type, it is possible to select a proper decoding unit. The decoding unit may be a corresponding decoding unit constructed according to different channel state types, and the decoding unit may decode the channel state indication information by using a decoding mode, for example, a specific decoding neural network, a specific decoding algorithm, a specific decoding model, corresponding to channel type information, and obtains recovered channel information after decoding.

The following will elaborate input information and output information as well as the structure of the channel state discriminative model.

The input information of the channel state discriminative model may include at least one of: (1) CSI indication information obtained after encoding of the channel information by the encoding unit, for example, indication information of CSI or indication information of channel information output by the encoding unit; (2) actual CSI corresponding to the channel state indication information obtained after encoding of the channel information by the encoding unit, for example, CSI or channel information corresponding to the CSI indication information, such as a corresponding channel eigenvector or a corresponding channel vector or channel matrix.

A format of the channel state indication information, the CSI, and/or the channel information may be specified in a protocol or configured by the network device, for example, configured by the network device (such as a base station) by means of at least one of: broadcast, a downlink control information (DCI) message, a media access control-control element (MAC CE) message, a radio resource control (RRC) message, downlink data transmission, or downlink data transmission with regard to Al service transmission requirements.

Different channel state indication information, CSI, and/or channel information indicates different channel states, for example, a type of the channel state may include at least one of: a channel state indication information type, a CSI type, or a channel type.

In some embodiments, the different channel state types described above are determined according to an environmental scenario and/or an index feature corresponding to the environmental scenario. An environmental scenario of a wireless channel includes, for example, at least one of: an indoor environment, an outdoor environment, a dense neighborhood, an open wild field, line of sight (LOS), non LOS (NLOS), high speed, or low speed. The index feature includes at least one of: time-domain feature information, frequency-domain feature information, or spatial feature information, for example, delay power spectrum information, multipath information, angle information, and speed information. Different scenarios and channel environments result in different types of the CSI indication information, the CSI, and the channel information, and differentiation of these types is exactly a function of the channel state discriminative unit.

The output of the channel state discriminative unit may include the channel state discriminative information obtained according to the channel state indication information, the CSI, and/or the channel information. The channel state discriminative information may be at least one of: an indication of a channel type, an indication of a CSI type, an indication of a channel state indication information type, an indication of a scenario type, an indication of a channel feature index type, an indication of an encoding scheme, or an indication of a decoding scheme. The channel state discriminative information may directly indicate unique type information, or may indicate a discriminative value indicating each type, such as a probability or grade of each type. Different types correspond to different decoding units, and each decoding unit corresponds to more than one channel state discriminative information. The amounts of channel state discriminative information corresponding to decoding units are the same or different.

Specifically, each channel state discriminative result corresponds to one decoding unit, or multiple channel state discriminative results corresponds to one decoding unit. The decoding unit may decode the received channel state indication information by using a decoding mode (such as a specific decoding neural network, a specific decoding algorithm, a specific decoding model, a specific decoding unit) corresponding to channel type information, so as to obtain recovered channel information.

A correspondence between type information and decoding units may be exemplified as shown in Table 1 below.

TABLE 1

| Type information (channel type) | Decoding unit |
|---|---|
| First channel type | First decoding unit |
| Second channel type | Second decoding unit |
| Third channel type | Third decoding unit |
| Fourth channel type | Fourth decoding unit |
| N^{th} channel type | N^{th} decoding unit |

An X^{th} channel type (the first channel type, the second channel type, . . . , the N^{th} channel type) may also be an X^{th} CSI type, or an X^{th} channel state indication information type, or an X^{th} scenario type, or an X^{th} channel feature index type, or an X^{th} encoding scheme type, or an X^{th} decoding scheme type, etc.

Another correspondence between type information and decoding units may be exemplified as shown in the Table 2 below.

TABLE 2

| Type information (channel type) | Decoding unit |
|---|---|
| First to fourth channel types | First decoding unit |
| Fourth to eighth channel types | Second decoding unit |
| Ninth to tenth channel types | Third decoding unit |
| Eleventh to twelfth channel types | Fourth decoding unit |
| N1^{th} to N2^{th} channel types | N^{th} decoding unit |

An X^{th} channel type (the first to N2^{th} channel types) may also be an X^{th} CSI type, an X^{th} channel state indication information type, an X^{th} scenario type, an X^{th} channel feature index type, an X^{th} encoding scheme type, an X^{th} decoding scheme type, etc. The foregoing multiple-to-one mapping between type information and decoding units may be an even mapping, or may be an uneven mapping, i.e. the amounts of type information corresponding to different decoding units may be the same or different.

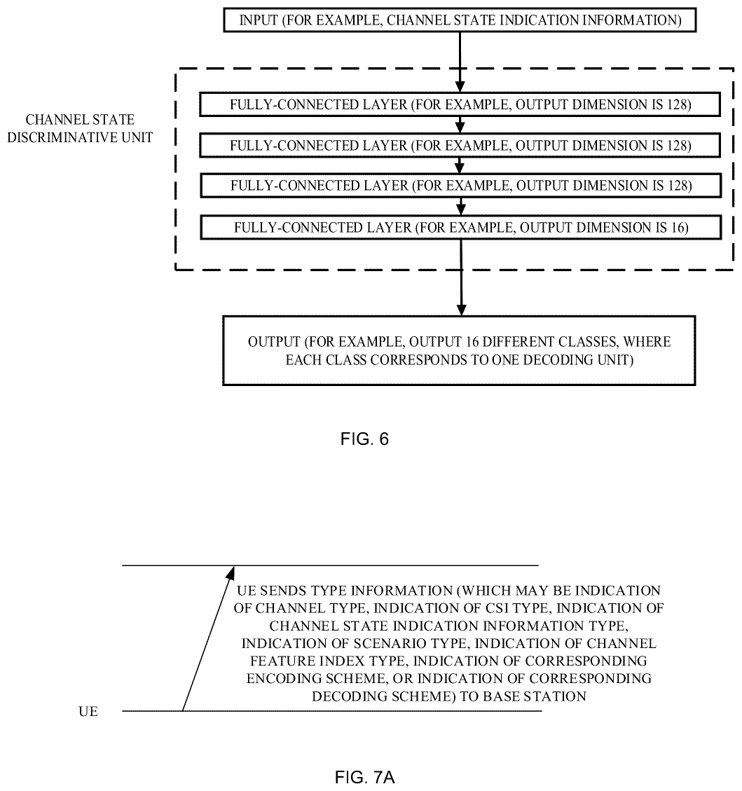

The channel state discriminative model may include at least one of: a classification neural network, a classification algorithm, or a classification model. Taking a machine-learning-based neural network as an example, the channel state discriminative model may be obtained by constructing the classification neural network. FIG. 6 is a schematic structural diagram illustrating a channel state discriminative model according to embodiments of the disclosure. As illustrated in FIG. 6, a simple classification network may be constructed by using a fully-connected network. An input is the channel state indication information/channel information/CSI, and an output is N different types, where each type corresponds to one decoding unit. The output may indicate that a discriminative result regarding the channel state indication information/channel information/CSI currently input is one of the multiple different types, or may indicate a possibility (possibilities) of all or some of the multiple different types corresponding to the discriminative result regarding the channel state indication information/channel information/CSI currently input. In addition, the channel state discriminative model implemented by using a neural network may further include at least one fully connected layer, a normalization layer, an activation function, a convolutional layer, and a pooling layer, and may also include a specific network structure, such as a recurrent neural network structure, a long-short term memory (LSTM), a residual structure, an attention mechanism.

The channel state discriminative model may be deployed at the terminal device, or may be deployed at the network device.

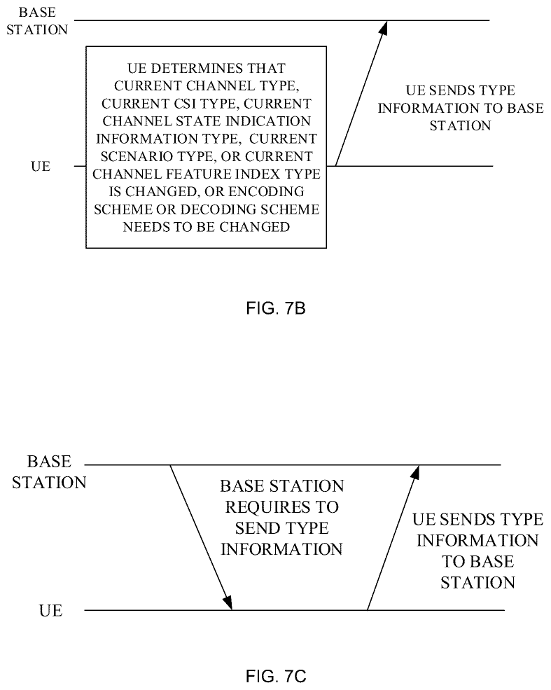

Exemplarily, the channel state discriminative model is deployed at the terminal device, and the method for information indication provided in embodiments of the disclosure may further include the following. If the channel state discriminative unit is deployed at a UE, the type information (which may be the indication of a channel type, the indication of a CSI type, the indication of a channel state indication information type, the indication of a scenario type, the indication of a channel feature index type, an indication of a corresponding encoding scheme, or an indication of a corresponding decoding scheme) output by the channel state discriminative model may be indicated to a base station by the UE, as illustrated in FIG. 7A.

When indicating the type described above, the UE may notify to the base station by means of at least one of: a random access procedure (for example, message 1 (msg1) or message 3 (msg3) in four-step random access or message A (msgA) in two-step random access), uplink control information (UCI), a physical uplink control channel (PUCCH), a physical uplink shared channel (PUSCH), an RRC message, uplink data transmission, uplink data transmission with regard to Al service transmission requirements, etc.

A manner for the terminal device to send the channel state discriminative information may include at least one of the following. Send periodically. Send according to at least one of the following indicated by the network device: a period, a time within a period, or a frequency-domain resource, for example, a base station may configure the period, the time within a period, and the frequency domain resource used for a UE to indicate the type described above, and the UE indicates the type information according to the period and the resource within the period.

For example, in some implementations, as illustrated in FIG. 7B, the UE sends the type information to the base station if at least one of a current channel state indication information type, a current CSI type, a current channel type, a current scenario type, or a current channel feature index type is changed. Alternatively, the UE sends the type information to the base station if the encoding scheme and/or the decoding scheme needs to be changed.

For another example, in some implementations, as illustrated in FIG. 7C, the UE indicates according to requirements of the base station. The UE notifies the type information to the base station if the base station requires the UE to report at least one of: the channel type, the CSI type, the channel state indication information type, the scenario type, the channel feature index type, the encoding scheme, or the decoding scheme.

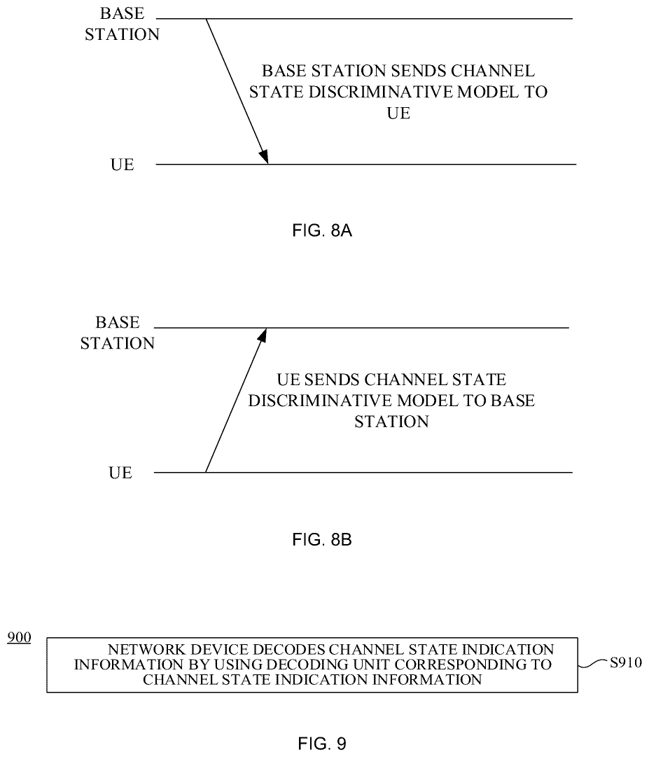

The channel state discriminative model may be trained by the network device or by the terminal device. If the channel state discriminative model is trained by the network device, the method for information indication implemented by the terminal device may further include the following before inputting the first information to the channel state discriminative model: the terminal device receives the channel state discriminative model. FIG. 8A is a schematic diagram illustrating an implementation of receiving the channel state discriminative model from a base station by a UE. The channel state discriminative model received by the terminal device is carried in at least one of: downlink control signaling, a MAC CE message, an RRC message, a broadcast message, downlink data transmission, or downlink data carrying with regard to Al service transmission requirements.

If the channel state discriminative model is trained by the terminal device, the method for information indication provided in embodiments of the disclosure may further include the following: the terminal device trains the channel state discriminative model by using sample information and channel state discriminative information corresponding to the sample information. The sample information may include samples of the channel information, samples of the CSI, and/or samples of the channel state indication information. The terminal device may send the trained channel state discriminative model to the network device. FIG. 8B is a schematic diagram illustrating an implementation of sending the channel state discriminative model to a base station by a UE. The channel state discriminative model sent by the terminal device is carried in at least one of: uplink control signaling, an RRC message, uplink data transmission, or uplink data transmission with regard to Al service transmission requirements.

If corresponding channel state discriminative information is obtained by the network device with aid of the channel state discriminative model, the method for information indication provided in embodiments of the disclosure may further include the following: the terminal device receives the channel state discriminative information, and selects a corresponding encoding unit according to the received channel state discriminative information.

Embodiments of the disclosure mainly focus on classification of the channel state indication information and matching of the decoding unit(s). In this way, it is possible to construct only at a receiving end different decoding units with respect to classification of different channel state indication information and then match the decoding units for use, thereby reducing burden of multi-model construction at an encoding end according to different scenarios. Specifically, embodiments of the disclosure provide an architecture of an adaptive scheme for CSI recovery, an input, output, and construction manner of the channel state discriminative model, and a joint working mode of the channel state discriminative model and the decoding unit. The channel state indication information provided in embodiments of the disclosure corresponds to different channel types, and a corresponding channel information decoding unit is matched according to a classification result and then used to decode the channel state indication information. With respect to channel complexity, in embodiments of the disclosure, different schemes for channel information compression, feedback, and recovery can be adopted regarding different channel types, thereby improving adaptability of channel information compression, feedback, and recovery to specific scenarios as well as improving performance gains. In addition, in embodiments of the disclosure, an encoding end (for example, a UE) is exempt from implementing the foregoing scenario adaptation, classification, and corresponding multi-model matching, thereby reducing implementation complexity of a scheme for scenario-adapted channel information compression, feedback, and recovery of the terminal device.

Embodiments of the disclosure further provide a method for information processing. FIG. 9 is a schematic flowchart of a method 900 for information processing according to embodiments of the disclosure. The method may be optionally applied to the system illustrated in FIG. 1, but is not limited thereto. The method includes at least some of the following contents.

S910, a network device decodes channel state indication information by using a decoding unit corresponding to the channel state indication information.

The channel state indication information may be received from a terminal device by the network device. Specifically, the terminal device may encode channel information or CSI by using an encoding unit, and send to the network device the channel state indication information obtained through encoding.

The network device may determine the decoding unit corresponding to the channel state indication information according to channel state discriminative information. For example, the method may further include the following. The network device receives the channel state discriminative information.

Specifically, the network device may receive the channel state discriminative information as follows. The network device receives the channel state discriminative information by means of at least one of: a random access procedure, UCI, a PUCCH, a PUSCH, an RRC message, or uplink data transmission.

For example, the network device receives the channel state discriminative information via at least one of: MSG1 or MSG3 in a four-step random access procedure or MSG A in a two-step random access procedure.

The method may further include the following. The network device indicates at least one of the following for sending the channel state discriminative information: a period, a time within a period, or a frequency-domain resource. In this way, according to an indication from the network device, the terminal device can send the channel state discriminative information according to the period, the time within a period, and the frequency domain resource.

Alternatively, the method may further include the following. The network device sends an instruction for reporting the channel state discriminative information. In this way, the terminal device can send the channel state discriminative information according to an indication from the network device.

In other embodiments, the channel state discriminative information is determined by the network device. For example, the network device inputs the channel state indication information into a channel state discriminative model to obtain the channel state discriminative information. For example, the channel state discriminative model may be pre-deployed at the network device, and the network device inputs the channel state indication information received from the terminal device into the channel state discriminative model to obtain corresponding channel state discriminative information.

Further, the network device may also send the channel state discriminative information. For example, the network device sends the channel state discriminative information to the terminal device, where the channel state discriminative information may be used for the terminal device to select a proper encoding scheme or encoding unit.

Specifically, the channel state discriminative information may include at least one of: an indication of a channel type, an indication of a CSI type, an indication of a channel state indication information type, an indication of a scenario type, an indication of a channel feature index type, an indication of an encoding scheme, or an indication of a decoding scheme.

The channel state indication information may be obtained through encoding of channel information and/or CSI by an encoding unit.

In some embodiments, at least one of a format of the channel information, a format of the CSI, or a format of the channel state indication information is specified in a protocol; and/or at least one of the format of the channel information, the format of the CSI, or the format of the channel state indication information is configured by the network device.

For example, at least one of the format of the channel information, the format of the CSI, or the format of the channel state indication may be configured by the network device by means of at least one of: broadcast, a DCI message, a MAC CE message, an RRC message, or downlink data transmission.

In addition, at least one of the channel state indication information, the channel information, or the CSI may indicate a corresponding channel state, and a type of the channel state may include at least one of: a channel state indication information type, a CSI type, or a channel type.

In some embodiments, the type of the channel state is determined according to an environmental scenario and/or an index feature corresponding to the environmental scenario.

For example, the environmental scenario includes at least one of: an indoor environment, an outdoor environment, a dense neighborhood, an open wild field, LOS, NLOS, high-speed movement, or low-speed movement.

For another example, the index feature includes at least one of: time-domain feature information, frequency-domain feature information, or spatial feature information.

In some embodiments, each decoding unit corresponds to at least one channel state discriminative information.

Further, the amounts of channel state discriminative information corresponding to decoding units are the same or different.

In some embodiments, the channel state discriminative model includes at least one of: a classification neural network, a classification algorithm, or a classification model.

The channel state discriminative model may be trained by the terminal device or the network device.

Accordingly, if the channel state discriminative model is trained by the terminal device, the method may further include the following. The network device receives the channel state discriminative model.

For example, the channel state discriminative model received by the network device is carried in at least one of: uplink control signaling, an RRC message, uplink data transmission, or uplink data transmission with regard to Al service transmission requirements.

Accordingly, if the channel state discriminative model is trained by the network device, the method may further include the following. The network device trains the channel state discriminative model by using sample information and channel state discriminative information corresponding to the sample information.

Further, the method may further include the following. The network device sends the channel state discriminative model.

For example, the channel state discriminative model sent by the network device is carried in at least one of: downlink control signaling, a MAC CE message, an RRC message, a broadcast message, downlink data transmission, or downlink data carrying with regard to Al service transmission requirements.

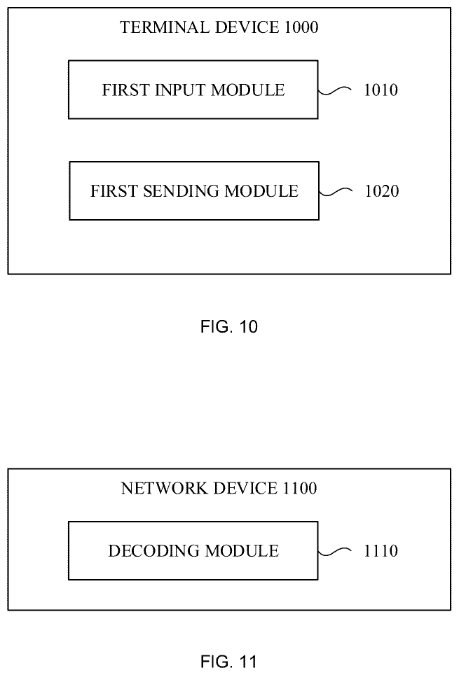

Embodiments of the disclosure further provide a terminal device. FIG. 10 is a schematic structural diagram of a terminal device 1000 according to embodiments of the disclosure. The terminal device 1000 includes a first input module 1010 and a first sending module 1020. The first input module 1010 is configured to input first information into a channel state discriminative model, to obtain corresponding channel state discriminative information. The first sending module 1020 is configured to send the channel state discriminative information.

In some implementations, the channel state discriminative information includes at least one of: an indication of a channel type, an indication of a CSI type, an indication of a channel state indication information type, an indication of a scenario type, an indication of a channel feature index type, an indication of an encoding scheme, or an indication of a decoding scheme.

In some implementations, the first information includes at least one of: channel information, CSI, or channel state indication information.

In some implementations, a format of the first information is specified in a protocol and/or configured by a network device.

In some implementations, the format of the first information is configured by the network device as follows. The format of the first information is configured by the network device by means of at least one of: broadcast, a DCI message, a MAC CE message, an RRC message, downlink data transmission, or downlink data transmission with regard to Al service transmission requirements.

In some implementations, the first information indicates a corresponding channel state, and a type of the channel state includes at least one of: a channel state indication information type, a CSI type, or a channel type.

In some implementations, the type of the channel state is determined according to an environmental scenario and/or an index feature corresponding to the environmental scenario.

In some implementations, the environmental scenario includes at least one of an indoor environment, an outdoor environment, a dense neighborhood, an open wild field, LOS, NLOS, high-speed movement, or low-speed movement.

In some implementations, the index feature includes at least one of: time-domain feature information, frequency-domain feature information, or spatial feature information.

In some implementations, the first sending module 1020 is configured to send the channel state discriminative information to the network device, to enable the network device to determine a corresponding decoding unit, where the decoding unit is used for decoding the channel state indication information.

In some implementations, each decoding unit corresponds to at least one channel state discriminative information.

In some implementations, the amounts of channel state discriminative information corresponding to decoding units are the same or different.

In some implementations, the terminal device further includes a second input module. The second input module is configured to input the channel information and/or the CSI into an encoding unit, to obtain channel state indication information.

In some implementations, the channel state discriminative information is sent by the first sending module 1020 by means of at least one of: a random access procedure, UCI, a PUCCH, a PUSCH, an RRC message, uplink data transmission, or uplink data transmission with regard to Al service transmission requirements.

In some implementations, the channel state discriminative information is sent by the first sending module 1020 via at least one of: MSG1 or MSG3 in a four-step random access procedure or MSG A in a two-step random access procedure.

In some implementations, a manner for the first sending module 1020 to send the channel state discriminative information includes at least one of: sending periodically; sending according to at least one of the following indicated by the network device: a period, a time within a period, or a frequency-domain resource; sending when at least one of a current channel state indication information type, a current CSI type, a current channel type, a current scenario type, or a current channel feature index type is changed; sending when the encoding scheme and/or the decoding scheme needs to be changed; or sending according to an instruction of the network device.

In some implementations, the channel state discriminative model includes at least one of: a classification neural network, a classification algorithm, or a classification model.

In some implementations, the terminal device further includes a first receiving module. The first receiving module is configured to receive the channel state discriminative model.

In some implementations, the channel state discriminative model is carried in at least one of: downlink control signaling, a MAC CE message, an RRC message, a broadcast message, downlink data transmission, or downlink data carrying with regard to Al service transmission requirements.

In some implementations, the terminal device further includes a first training module. The first training module is configured to train the channel state discriminative model by using sample information and channel state discriminative information corresponding to the sample information.

In some implementations, the terminal device further includes a second sending module. The second sending module is configured to send the channel state discriminative model.

In some implementations, the channel state discriminative model is carried in at least one of: uplink control signaling, an RRC message, uplink data transmission, or uplink data transmission with regard to Al service transmission requirements.

In some implementations, the terminal device further includes a second receiving module. The second receiving module is configured to receive the channel state discriminative information, and select a corresponding encoding unit according to the received channel state discriminative information.

It should be understood that, the foregoing and other operations and/or functions of the modules in the terminal device according to embodiments of the disclosure are intended to implement corresponding procedures of the terminal device in the method 400 in FIG. 4, which will not be described again herein for the sake of brevity.

Embodiment of the disclosure further provides a network device. FIG. 11 is a schematic structural diagram of a network device 1100 according to embodiments of the disclosure. The network device 1100 includes a decoding module 1110. The decoding module 1110 is configured to decode channel state indication information by using a decoding unit corresponding to the channel state indication information.

In some implementations, the network device further includes a determining module. The determining module is configured to determine the decoding unit corresponding to the channel state indication information according to channel state discriminative information.

In some implementations, the network device further includes a third receiving module. The third receiving module is configured to receive the channel state discriminative information.

In some implementations, the third receiving module is configured to receive the channel state discriminative information by means of at least one of: a random access procedure, UCI, a PUCCH, a PUSCH, an RRC message, uplink data transmission, or uplink data transmission with regard to artificial intelligent service transmission requirements.

In some implementations, the third receiving module is configured to receive the channel state discriminative information via at least one of: MSG1 or MSG3 in a four-step random access procedure or MSG A in a two-step random access procedure.

In some implementations, the network device further includes a first indicating module. The first indicating module is configured to indicate at least one of the following for sending the channel state discriminative information: a period, a time within a period, or a frequency domain resource.

In some implementations, the network device further includes a second indicating module. The second indicating module is configured to send an instruction for reporting the channel state discriminative information.

In some implementations, the network device further includes a third input module. The third input module is configured to input the channel state indication information into a channel state discriminative model, to obtain the channel state discriminative information.

In some implementations, the network device further includes a third sending module. The third sending module is configured to send the channel state discriminative information.

In some implementations, the channel state discriminative information includes at least one of: an indication of a channel type, an indication of a CSI type, an indication of a channel state indication information type, an indication of a scenario type, an indication of a channel feature index type, an indication of an encoding scheme, or an indication of a decoding scheme.

In some implementations, the channel state indication information is obtained through encoding of channel information and/or CSI by an encoding unit.

In some implementations, at least one of a format of the channel information, a format of the CSI, or a format of the channel state indication is specified in a protocol; and/or at least one of a format of the channel information, a format of the CSI, or a format of the channel state indication is configured by the network device.

In some implementations, at least one of the format of the channel information, the format of the CSI, or the format of the channel state indication is configured by the network device as follows. At least one of the format of the channel information, the format of the CSI, or the format of the channel state indication is configured by the network device by means of at least one of: broadcast, a DCI message, a MAC CE message, an RRC message, downlink data transmission, or downlink data transmission with regard to Al service transmission requirements.

In some implementations, at least one of the channel state indication information, the channel information, or the CSI indicates a corresponding channel state, and a type of the channel state includes at least one of: a channel state indication information type, a CSI type, or a channel type.

In some implementations, the type of the channel state is determined according to an environmental scenario and/or an index feature corresponding to the environmental scenario.

In some implementations, the environmental scenario includes at least one of: an indoor environment, an outdoor environment, a dense neighborhood, an open wild field, LOS, NLOS, high-speed movement, or low-speed movement.

In some implementations, the index feature includes at least one of: time-domain feature information, frequency-domain feature information, or spatial feature information.

In some implementations, each decoding unit corresponds to at least one channel state discriminative information.

In some implementations, the amounts of channel state discriminative information corresponding to decoding units are the same or different.

In some implementations, the channel state discriminative model includes at least one of: a classification neural network, a classification algorithm, or a classification model.

In some implementations, the network device further includes a fourth receiving module. The fourth receiving module is configured to receive the channel state discriminative model.

In some implementations, the channel state discriminative model is carried in at least one of: uplink control signaling, an RRC message, uplink data transmission, or uplink data transmission with regard to Al service transmission requirements.

In some implementations, the network device further includes a second training module. The second training module is configured to train the channel state discriminative model by using sample information and channel state discriminative information corresponding to the sample information.

In some implementations, the network device further includes a fourth sending module. The fourth sending module is configured to send the channel state discriminative model.

In some implementations, the channel state discriminative model is carried in at least one of: downlink control signaling, a MAC CE message, an RRC message, a broadcast message, downlink data transmission, or downlink data carrying with regard to Al service transmission requirements.

It should be understood that, the foregoing and other operations and/or functions of the modules in the network device according to embodiments of the disclosure are intended to implement corresponding procedures of the network device in the method 900 in FIG. 9, which will not be described again herein for the sake of brevity.

It should be noted that, the described functions of various modules (sub-models, units, or components) in the terminal device 1000 and the network device 1100 in embodiments of the disclosure may be implemented by different modules (sub-models, units, or components), or may be implemented by the same module (sub-models, units, or components). For example, the first input module and the second input module may be different modules or may be the same module, all of which can achieve the corresponding functions thereof in embodiments of the disclosure. In addition, the sending module and the receiving module in embodiments of the disclosure may be implemented by a transceiver of a device, and some or all of the other modules may be implemented by a processor of the device.

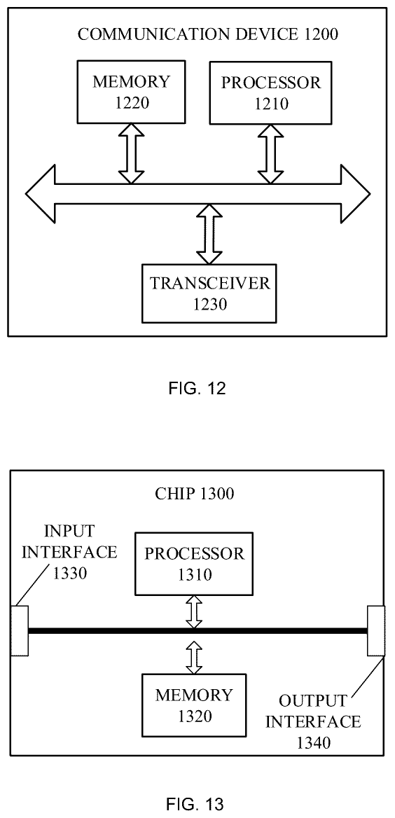

FIG. 12 is a schematic structural diagram of a communication device 1200 according to embodiments of the disclosure. The communication device 1200 illustrated in FIG. 12 includes a processor 1210. The processor 1210 can invoke and execute computer programs stored in a memory, to implement the method in embodiments of the disclosure.

Optionally, as illustrated in FIG. 12, the communication device 1200 may further include a memory 1220, where the processor 1210 can invoke and execute computer programs stored in the memory 1220 to implement the method in embodiments of the disclosure.

The memory 1220 may be a separate device independent of the processor 1210, or may be integrated into the processor 1210.

Optionally, as illustrated in FIG. 12, the communication device 1200 may further include a transceiver 1230. The processor 1210 can control the transceiver 1230 to communicate with other devices, and specifically, to send information or data to other devices or receive information or data sent by other devices.

The transceiver 1230 may include a transmitter and a receiver. The transceiver 1230 can further include an antenna, where one or more antennas may be provided.

Optionally, the communication device 1200 may be a terminal device in embodiments of the disclosure, and the communication device 1200 may implement corresponding operations implemented by the terminal device in various methods in embodiments of the disclosure, which will not be described again herein for the sake of brevity.

Optionally, the communication device 1200 may be a network device in embodiments of the disclosure, and the communication device 1200 may implement corresponding operations implemented by the network device in various methods in embodiments of the disclosure, which will not be described again herein for the sake of brevity.

FIG. 13 is a schematic structural diagram of a chip according to embodiments of the disclosure. The chip 1300 illustrated in FIG. 13 includes a processor 1310. The processor 1310 can invoke and execute computer programs stored in a memory, so as to implement the method in embodiments of the disclosure.

Optionally, as illustrated in FIG. 13, the chip 1300 may further include a memory 1320. The processor 1310 can invoke and execute computer programs stored in the memory 1320, so as to implement the method in embodiments of the disclosure.

The memory 1320 may be a separate device independent of the processor 1310, or may be integrated into the processor 1310.

Optionally, the chip 1300 may further include an input interface 1330. The processor 1310 can control the input interface 1330 to communicate with other devices or chips, and specifically, to obtain information or data sent by other devices or chips.

Optionally, the chip 1300 may further include an output interface 1340. The processor 1310 can control the output interface 1340 to communicate with other devices or chips, and specifically, to output information or data to other devices or chips.

Optionally, the chip may be applied to the terminal device in embodiments of the disclosure, and the chip may implement corresponding operations implemented by the terminal device in various methods in embodiments of the disclosure, which will not be described again herein for the sake of brevity.

Optionally, the chip may be applied to the network device in embodiments of the disclosure, and the chip may implement corresponding operations implemented by the network device in various methods in embodiments of the disclosure, which will not be described again herein for the sake of brevity.

It should be understood that, the chip in embodiments of the disclosure may also be referred to as a system-on-chip (SOC).

The foregoing processor may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor or any conventional processor.

The memory described above may be volatile memory or non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that, the memory above is intended for illustration rather than limitation. For example, the memory in embodiments of the disclosure may also be a static RAM) SRAM), a dynamic RAM (DRAM), a synchronous DRAM (SDRAM), a double data rate SDRAM (DDR SDRAM), an enhanced SDRAM (ESDRAM), and a synch link DRAM (SLDRAM), and a direct rambus RAM (DR RAM), etc. That is, the memory in embodiments of the disclosure is intended to include, but not limited to, these and any other suitable types of memory.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It should be understood that, in various embodiments of the disclosure, the magnitude of a sequence number of each of the foregoing processes does not imply an execution order, and the execution order between the processes should be determined according to function and internal logic thereof, which shall not constitute any limitation to the implementation of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be described in detail again herein.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A terminal device, comprising:
a transceiver;
a memory configured to store a computer programs; and
a processor configured to execute the computer programs stored in the memory, to input first information into a channel state discriminative model, to obtain corresponding channel state discriminative information;
wherein the transceiver is configured to send the channel state discriminative information.

2. The terminal device of claim 1, wherein the first information comprises at least one of: channel information, CSI, or channel state indication information.

3. The terminal device of claim 1, wherein a format of the first information is specified in a protocol and/or configured by a network device; and
wherein the format of the first information being configured by the network device comprises: the format of the first information being configured by the network device by means of at least one of: broadcast, a downlink control information (DCI) message, a media access control-control element (MAC CE) message, a radio resource control (RRC) message, downlink data transmission, or downlink data transmission with regard to artificial intelligence (AI) service transmission requirements.

4. The terminal device of claim 1, wherein the first information indicates a corresponding channel state, and a type of the channel state comprises at least one of: a channel state indication information type, a CSI type, or a channel type.

5. The terminal device of claim 4, wherein the type of the channel state is determined according to an environmental scenario and/or an index feature corresponding to the environmental scenario;
wherein the environmental scenario comprises at least one of: an indoor environment, an outdoor environment, a dense neighborhood, an open wild field, line of sight (LOS), non LOS (NLOS), high-speed movement, or low-speed movement; and
wherein the index feature comprises at least one of: time-domain feature information, frequency-domain feature information, or spatial feature information.

6. The terminal device of claim 1, wherein the processor is further configured to invoke and execute the computer programs stored in the memory to:
input the channel information and/or the CSI into an encoding unit, to obtain channel state indication information.

7. The terminal device of claim 1, wherein the channel state discriminative information is sent by means of at least one of: a random access procedure, uplink control information (UCI), a physical uplink control channel (PUCCH), a physical uplink shared channel (PUSCH), an RRC message, uplink data transmission, or uplink data transmission with regard to Al service transmission requirements.

8. The terminal device of claim 1, wherein a manner to send the channel state discriminative information comprises at least one of:
sending periodically;
sending according to at least one of the following indicated by a network device: a period, a time within a period, or a frequency-domain resource;
sending when at least one of a current channel state indication information type, a current CSI type, a current channel type, a current scenario type, or a current channel feature index type is changed;
sending when an encoding scheme and/or a decoding scheme needs to be changed; or
sending according to an instruction of the network device.

9. The terminal device of claim 1, wherein the processor is further configured to invoke and execute the computer programs stored in the memory to:
train the channel state discriminative model by using sample information and channel state discriminative information corresponding to the sample information.

10. The terminal device of claim 1, wherein the transceiver is configured to:
send the channel state discriminative model.

11. The terminal device of claim 10, wherein the channel state discriminative model is carried in at least one of: uplink control signaling, an RRC message, uplink data transmission, or uplink data transmission with regard to Al service transmission requirements.

12. The terminal device of claim 1, wherein the transceiver is configured to:
receive the channel state discriminative information, and selecting a corresponding encoding unit according to the channel state discriminative information received.

13. A network device, comprising:
a transceiver;
a memory configured to store a computer programs; and
a processor configured to execute the computer programs stored in the memory, to decode channel state indication information by using a decoding unit corresponding to the channel state indication information.

14. The network device of claim 13, wherein the transceiver is configured to receive channel state discriminative information; and
wherein the processor is configured to invoke and execute the computer programs stored in the memory to determine the decoding unit corresponding to the channel state indication information according to channel state discriminative information.

15. The network device of claim 14, wherein the channel state discriminative information comprises at least one of:
an indication of a channel type;
an indication of a channel state information (CSI) type;
an indication of a channel state indication information type;
an indication of a scenario type;
an indication of a channel feature index type;
an indication of an encoding scheme; or
an indication of a decoding scheme.

16. The network device of claim 14, wherein the processor is configured to invoke and execute the computer programs stored in the memory to:
train a channel state discriminative model by using sample information and channel state discriminative information corresponding to the sample information.

17. The network device of claim 16, wherein the channel state discriminative model comprises at least one of: a classification neural network, a classification algorithm, or a classification model.

18. The network device of claim 16, wherein the transceiver is configured to:
send the channel state discriminative model.

19. The network device of claim 18, wherein the channel state discriminative model is carried in at least one of: downlink control signaling, a media access control-control element (MAC CE) message, a radio resource control (RRC) message, a broadcast message, downlink data transmission, or downlink data transmission with regard to artificial intelligence (AI) service transmission requirements.

20. A method for information processing, comprising:
decoding, by a network device, channel state indication information by using a decoding unit corresponding to the channel state indication information.
